(19) United States
(12) Patent Application Publication
(10) Pub. No.: US 2013/0159554 A1
(43) Pub. Date: Jun. 20, 2013

(54) METHOD OF PERFORMING DISTRIBUTED SYNCHRONIZATION IN AD HOC NETWORK SYSTEM

(71) Applicants: Ji Hung KIM, Daejeon-si (KR); Jung Hyun Kim, Daejeon-si (KR); Hyun Jae Kim, Incheon-si (KR); Kwang Jae Lim, Daejeon-si (KR); Dong Seung Kwon, Daejeon-si (KR)

(72) Inventors: Ji Hung KIM, Daejeon-si (KR); Jung Hyun Kim, Daejeon-si (KR); Hyun Jae Kim, Incheon-si (KR); Kwang Jae Lim, Daejeon-si (KR); Dong Seung Kwon, Daejeon-si (KR)

(73) Assignee: ELECTRONICS AND TELECOMMUNICATIONS RESEARCH INSTITUTE, Daejeon-si (KR)

(21) Appl. No.: 13/550,124

(22) Filed: Jul. 16, 2012

(30) Foreign Application Priority Data
Dec. 15, 2011 (KR) 10-2011-0135080

(51) Int. Cl. G06F 15/16

(52) U.S. Cl. 709/248

(57) ABSTRACT

There is provided a method of performing distributed synchronization in an Ad hoc network system. The method includes receiving a signal, including a reception time point change period, through a plurality of nodes, changing a reception time point at which the signal is received through the plurality of nodes within the reception time point change period so that the reception time point is included in a preset Cyclic Prefix (CP) period, changing a Fast Fourier Transform (FFT) start time point which is a time point at which data starts being recovered based on the changed reception time point, and changing the reference point of the transmission time point of each of the plurality of nodes based on a difference value between the preset reference point of the FFT start time point and the changed FFT start time point. The method has smaller overhead.

Priority to Korean patent application number 10-2011-01 35080 filed on Dec. 15, 2011, the entire disclosure of which is incorporated by reference herein, is claimed.

### BACKGROUND OF THE INVENTION

1. Field of the Invention

The present invention relates to an Ad hoc network system and, more particularly, to a method of performing distributed synchronization in an Ad hoc network system.

2. Discussion of the Related Art

An Ad hoc network refers to an autonomous and temporary network which is configured between independent terminals without external help, and it is also called a mesh network. The topology of the Ad hoc network is dynamically changed owing to free movement within the Ad hoc network, and the Ad hoc network is configured only when mobile terminals are close to each other and is ad hoc configured without any central control or standard support service. In the Ad hoc network, an information transfer method may be a one-to-one multi-hop routing method. The Ad hoc network can transmit or receive messages transmitted from nodes and may also play the role of a router. Although a connection is cut off, the Ad hoc network can automatically send a message through another connection. In the Ad hoc network, a signal becomes much better as nodes are closer to each other, and nodes can be simply added.

In synchronizing nodes in the Ad hoc network, a method of synchronizing a node that has transmitted a beacon with the Ad hoc network on the basis of time information of the node is commonly based on a precondition that the distance between nodes is within a permitted range (e.g., when the distance between nodes is similar or propagation delay is not great). Accordingly, there is a need for a method of performing distributed synchronization by taking propagation delay according to the distance into consideration when the distance between nodes is different.

Furthermore, if a Cyclic Prefix (CP) is inserted into each symbol when a CP longer than propagation delay is used, there is a disadvantage in that overhead is great. Accordingly, there is a need for a synchronization method by taking the disadvantage into account.

### SUMMARY OF THE INVENTION

It is an object of the present invention to provide a method and apparatus for performing synchronization by taking propagation delay according to the distance into consideration when the distance between nodes is different.

In accordance with an aspect of the present invention, there is provided a method of performing distributed synchronization in an Ad hoc network system, comprising receiving a signal, including a reception time point change period, through a plurality of nodes, changing a reception time point at which the signal is received through the plurality of nodes within the reception time point change period so that the reception time point is included in a preset Cyclic Prefix (CP) period, changing a Fast Fourier Transform (FFT) start time point which is a time point at which data starts being recovered based on the changed reception time point, and changing the reference point of the transmission time point of each of the plurality of nodes based on a difference value between the preset reference point of the FFT start time point and the changed FFT start time point.

The reception time point change period may exist between frames or subframes forming the signal.

The reception time point change period may be changed with consideration taken of propagation delay occurring when the signal is transmitted.

The reception time point may be changed by using Round-Trip Delay (RTD), estimated according to a ranging process in which the plurality of nodes is synchronized with reference timing in order to perform multi-access to one center node without interference or collision, and the transmission time point of each of the plurality of nodes.

The CP period may be determined by excluding the region where Inter-Symbol Interference (ISI) is generated.

The FFT start time point may be changed so that the FFT start time point approaches the preset reference point of the FFT start time point to the maximum extent.

The FFT start time point may be changed within the CP period changed on the basis of the fastest reception time point, from among reception time points at which the signal is received through the plurality of nodes.

If there is a node not included in the CP period, the FFT start time point may be changed within the CP period recalculated and changed by excluding a node having a slowest reception time point, and the reference point of the transmission time point of each of the plurality of nodes may be changed based on the excluded node.

The FFT start time point may be changed within the CP period changed on the basis of an average time point of the reception time points at which the signal is received through the plurality of nodes.

If there is a node not included in the CP period, the FFT start time point may be changed within the CP period changed on the basis of an average time point of the reception time points which is recalculated by excluding a node having the greatest difference in the reception time point from the average time point of the reception time points, and the reference point of the transmission time point of each of the plurality of nodes may be changed on the basis of the excluded node.

Each of the plurality of nodes may be a one-hop node.

The method may further include calculating reception time points at which a first node receives respective signals transmitted from the plurality of nodes, wherein the FFT start time point may be changed into a time point at which all the CP periods started from the respective calculated reception time points cross each other.

In accordance with another aspect of the present invention, there is provided a method of performing distributed synchronization in an Ad hoc network system, comprising transmitting a signal, including a transmission time point change period, through a plurality of nodes, changing a transmission time point at which the signal is transmitted through the plurality of nodes within the transmission time point change period so that the transmission time point is included in a preset Cyclic Prefix (CP) period, and changing the reference point of a Fast Fourier Transform (FFT) start time point which is a time point at which data starts being recovered based on the changed transmission time point.

The transmission time point change period may exist between frames or subframes forming the signal.

The transmission time point change period may be changed with consideration taken of propagation delay occurring when the signal is transmitted.

The transmission time point may be changed by using Round-Trip Delay (RTD), estimated according to a ranging process in which the plurality of nodes is synchronized with reference timing in order to perform multi-access to one center node without interference or collision, and a reception time point of each of the plurality of nodes.

The CP period may be determined by excluding the region where Inter-Symbol Interference (ISI) is generated.

The transmission time point may be changed within the CP period changed on the basis of the fastest reception time point, from among reception time points at which the signal is received through the plurality of nodes.

The transmission time point may be changed within the CP period changed on the basis of an average time point of reception time points at which the signal is received through the plurality of nodes.

In accordance with yet another aspect of the present invention, there is provided an Ad hoc network system, comprising a transmission terminal including a plurality of nodes and a reception terminal including a plurality of nodes. The transmission terminal transmits a signal including a transmission time point change period, changes a transmission time point at which the signal including the transmission time point change period is transmitted within the transmission time point change period so that the transmission time point is included within a preset first CP period, and changes a first FFT start time point based in the changed transmission time point. The reception terminal receives a signal including a reception time point change period, changes a reception time point at which the signal including the reception time point change period is received within the reception time point change period so that the reception time point is included in a preset second CP period, changes a second FFT start time point based on the changed reception time point, and changes a reference point of a transmission time point of the signal based on a difference value between a preset reference point of the second FFT start time point and the changed second FFT start time point.

### BRIEF DESCRIPTION OF THE DRAWINGS

The accompany drawings, which are included to provide a further understanding of this document and are incorporated on and constitute a part of this specification illustrate embodiments of this document and together with the description serve to explain the principles of this document.

FIG. 1 is an example showing an Ad hoc network system to which the present invention is applied;

FIG. 2 shows a Guard Period (GP) between frames or subframes which is applied to the present invention;

FIG. 3 is a diagram showing that the reception time point of a reception terminal is changed according to the present invention;

FIG. 4 is another diagram showing that reception time points are changed according to the present invention;

FIG. 5 is yet another diagram showing that a transmission time point or a reception time point is changed according to the present invention;

FIG. 6 is a flowchart illustrating an example of a method of performing distributed synchronization in an Ad hoc network system according to the present invention; and

FIG. 7 is a flowchart illustrating another example of a method of performing distributed synchronization in an Ad hoc network system according to the present invention.

### DETAILED DESCRIPTION OF THE EMBODIMENTS

Hereinafter, some embodiments of the present invention are described in detail with reference to the accompanying drawings in order for those skilled in the art to be able to readily implement the invention. However, the present invention may be modified in various different forms and are not limited to the following embodiments. In order to clarify a description of the present invention, parts not related to the description are omitted, and the same reference numbers are used throughout the drawings to refer to the same or like parts.

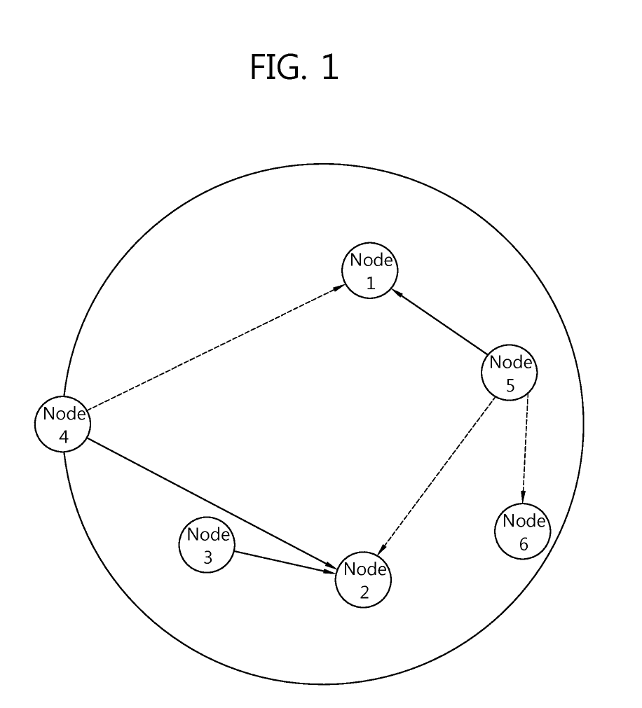

FIG. 1 is an example showing an Ad hoc network system to which the present invention is applied.

Referring to FIG. 1, when a node 3 and a node 4 transmit data to a node 2 and a node 5 transmits data to a node 1, the node 1 within a one-hop distance from the node 4 may experience interference, and the node 2 and a node 6 within a one-hop distance from the node 5 may experience interference.

The present invention relates to a method of enabling all the nodes to communicate with each other without interference by changing the reception time points of nodes within a one-hop distance in which interference may be generated or the transmission time points of nodes that may generate interference.

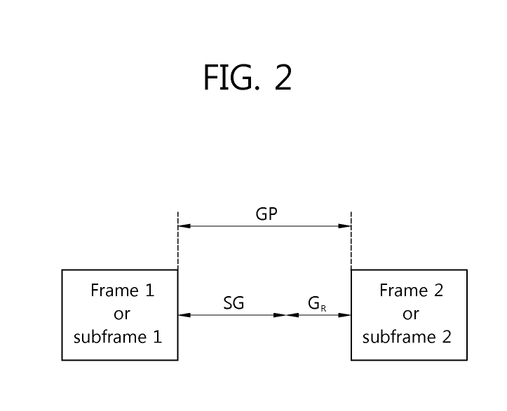

FIG. 2 shows a Guard Period (hereinafter referred to as a ‘GP’) between frames or subframes which is applied to the present invention.

Referring to FIG. 2, the GP between frames or subframes includes a Switching Gap (hereinafter referred to as an ‘SG’) and a reception time point change period G_{R}.

There is a characteristic that, when a plurality of nodes transmit signals, a time point at which a reception node receives each of the signals transmitted from the nodes has only to be within a CP_{F} (=CP−CP_{M}) period. Here, CP is a cyclic prefix, and it means a fixed period for preventing interference. CP_{M} is the region where Inter-Symbol Interference (ISI) is generated during the CP period.

If the CP of a basic length used in the existing infrastructure in which ISI due to the multiple paths of channels is prevented is used, a specific CP is additionally inserted between frames or subframes, and propagation delay according to the distance between nodes is estimated using a ranging method, overhead less than overhead, occurring when a CP longer than propagation delay according to the distance between the nodes is inserted into each symbol, is generated because the frame or subframe consists of a plurality of symbols. Here, the ranging method refers to a method in which several nodes spaced apart from each other are synchronized with reference timing in order to perform multiple-access to one center node without interference or a collision.

If a reception terminal tries to change a reception time point using a specific CP as described above, the reception time point change period G_{R} is added to the existing SG between frames or subframes. Here, the SG refers to the time taken for a node to be changed from transmission to reception or from reception to transmission, and G_{R} refers to a period where a reception time point is changed so that the reception time points of signals transmitted from a plurality of nodes is within a CP according to the present invention.

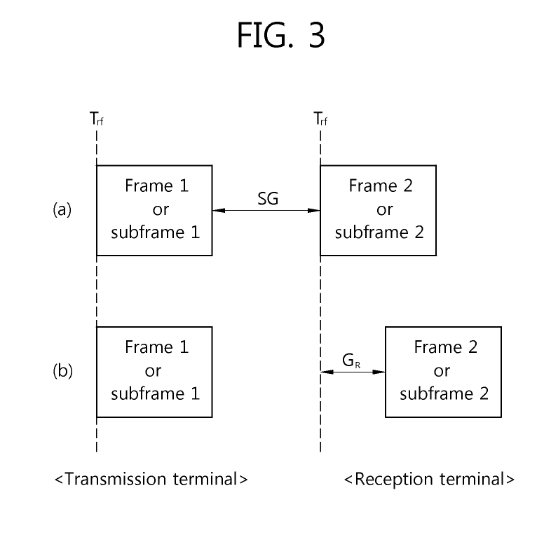

FIG. 3 is a diagram showing that the reception time point of a reception terminal is changed according to the present invention.

Referring to FIG. 3, it is assumed that transmission terminals for all the nodes start transmission at a transmission reference time T_{rf}. The transmission reference time T_{rf} may be set by a node that enters a Global Positioning System (GPS) or a network for the first time.

In case of (a), a reception reference time t_{rf} in a reception terminal is the time in which the length of a frame or subframe and an SG are added to the transmission reference time T_{rf}.

In case of (b), however, the reception terminal receives a relevant signal at a time point spaced apart from the reception reference time t_{rf} by G_{R} by taking propagation delay into consideration. In this case, the reception terminal can know the reception time point of each transmission node because it knows the transmission reference time T_{rf} when the signal is transmitted from the transmission terminal and propagation delay according to the distance of each node by using a ranging method.

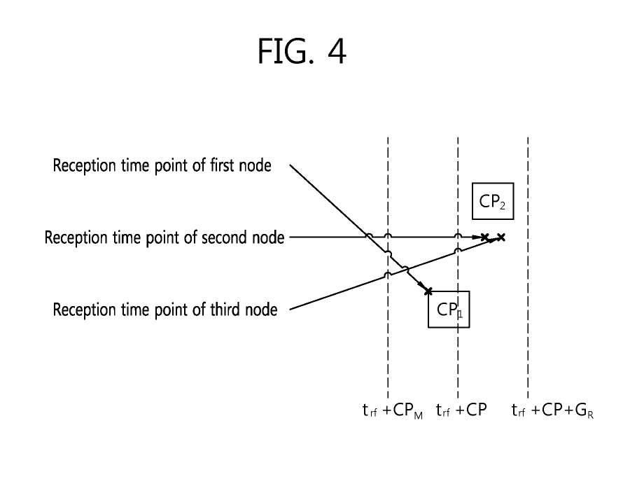

FIG. 4 is another diagram showing that reception time points are changed according to the present invention. A reception time point is changed if time points at which respective signals transmitted from a plurality of nodes are received are different.

Referring to FIG. 4, a reception terminal may set a Fast Fourier Transform (hereinafter referred to as ‘FFT’) start time point within a period longer than the existing CP length by using a GP (or G_{R}) between frames or subframes. Here, the FFT start time point refers to the start time point at which the reception terminal recovers data. In this case, the period that may be set is “t_{rf}+CP_{M}” to “t_{rf}+G_{R}+CP”. Here, the CP may be set as the CP having a basic length which is used in the existing infrastructure for preventing Inter-Symbol Interference (ISI) due to the multiple paths of channels.

If a plurality of nodes transmits signals, reception time points are different depending on the propagation delay of each node. Accordingly, the FFT start time point is changed and set so that an interval between all the reception time points becomes within a length CP_{F} in the range of “t_{rf}+CP_{M}” to “t_{rf}+G_{R}+CP”.

For example, if signals are received from a plurality of nodes, the FFT start time point may be set in a period of a length CP_{F} after CP_{M} on the basis of a node having the fastest reception time point, from among the plurality of the nodes. For example, if a first node, a second node, and a third node have different reception time points in FIG. 4, a period (i.e., CP₁) from the reception time point of the first node having the fastest reception time point to a CP after CP_{M} may be set as an available reception period. In this case, the influence of a node that has not received a signal within the CP_{F} (=CP−CP_{M}) period is relatively small because a node having the fastest reception time point has the greatest power.

For another example, if signals are received from a plurality of nodes, the FFT start time point may be set in a period from an average reception time point of the signals at which the signals are received from the plurality of nodes to a CP after CP_{M} on the basis of the average reception time point. For example, a period (i.e., CP₂) from an average reception time point of the reception time points of the first node, the second node, and the third node in FIG. 4 to a CP after CP_{M} may be set as an available reception period. In this case, the number of nodes that receives signals within the period CP₂ can be increased, distributed synchronization for a plurality of nodes can be performed, and there is an advantage in terms of simultaneous detection for a plurality of nodes.

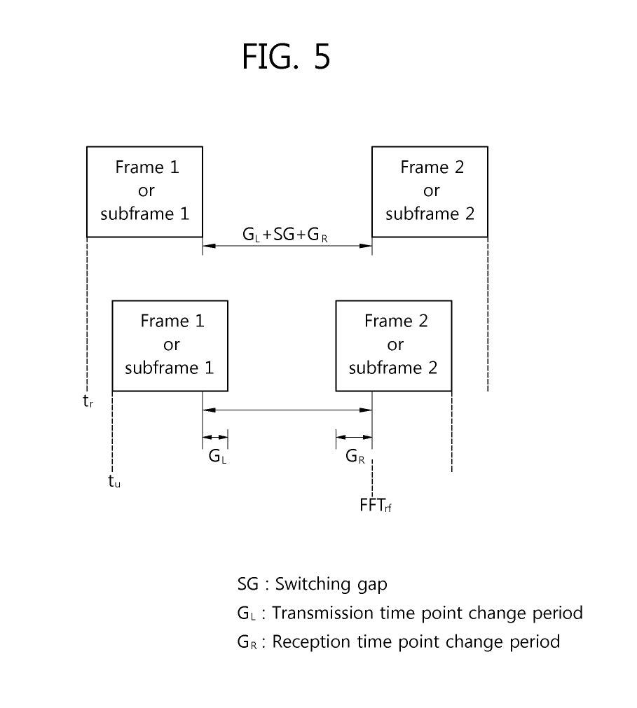

FIG. 5 is yet another diagram showing that a transmission time point or a reception time point is changed according to the present invention. Not only a reception time point, but also a transmission time point may be changed, and a reception time point and a transmission time point may be changed at the same time.

Referring to FIG. 5, assuming that the transmission time point of a node e that changes the transmission time point and the reception time point in order to perform distributed synchronization is Tₑ, the node e compares the transmission time point Tₑ with a reference transmission start time point T_{rf} and broadcasts a signal to neighboring nodes with a time lag ΔTₑ (=Tₑ−T_{rf}). It is hereafter assumed that a maximum value of the time lag ΔTₑ is G_{L} and a minimum value thereof is G_{R}.

Assuming that the FFT start time point of the node e is FFTₑ, the node e compares the FFT start time point FFTₑ with a reference FFT start time point FFT_{rf} (=T_{rf}+CP) and broadcasts a signal to neighboring nodes with a time lag ΔFFTₑ (=FFTₑ−FFT_{rf}). It is hereinafter assumed that a maximum value of “ΔFFTₑ−RTDₑₙ/2” is G_{L} and a minimum value thereof is G_{R} for the one-hop node n of the node e. RTDₑₙ is a Round-Trip Delay (RTD) value between a node e and a neighboring node n

Assuming that the reference point of an initial transmission time point of all the nodes accessing a system is T_{cr}, the reference point T_{cr} has a time lag ΔT_{cr} (=T_{cr}−T_{rf}) with the reference transmission start time point T_{rf}. The value ΔT_{cr} may be randomly fixed in the system and is hereinafter assumed to be 0. Furthermore, the reference transmission start time point T_{cre} of the node e has the reference point T_{cr} as an initial value, and it is continuously changed as distributed synchronization is performed.

Assuming that the reference point of an initial FFT start time point of all the nodes accessing a system is FFT_{cr}, the reference point FFT_{cr} has a time lag ΔFFT_{cr} (=FFT_{cr}−FFT_{rf}) with the reference FFT start time point FFT_{rf}. This value ΔFFT_{cr} may be randomly fixed in the system and is hereinafter assumed to be 0. Furthermore, the reference FFT start time point FFT_{cre} of the node e uses the reference point FFT_{cr} as an initial value, and it is continuously changed as distributed synchronization is performed.

It is hereinafter assumed that the reference transmission start time point T_{rf} is 0, for the sake of convenience. Furthermore, a set of one-hop nodes of the node e is defined to be x(={n:n∈{ . . . , i, j, k, . . . ,}}). Here, i, j, k, and n are one-hop node indices. The one-hop node indices i, j, k, and n are used to distinguish the one-hop nodes from each other, and i, j, k, and n may be identical with each other.

Meanwhile, in order to perform distributed synchronization according to the present invention, a method of determining the reception time point and the FFT start time point of each node and changing the transmission time points of one-hop nodes (embodiment 1) and a method of determining the transmission time point of a node and changing the FFT start time points of one-hop nodes (embodiment 2) may be used.

The method of determining the reception time point and the FFT start time point of each node and changing the transmission time points of one-hop nodes in order to perform distributed synchronization (embodiment 1) is described below. Like all the nodes, a node e may set a range of an FFT start time point FFTₑ at which a signal is received in the existing network as in Equation below.

FFT_{L}≦FFTₑ≦FFT_{R} [Equation 1]

If the node e is an entry node, FFT_{L} may be set to “−G_{R}” and FFT_{R} may be set to “G_{L}+CP” as the initial values of the above range value.

The node e estimates a Round-Trip Delay (RTD) value RTDₑₙ with a neighboring node n in accordance with a ranging method and calculates a reception time point tₙₑ at which a signal transmitted from the node n reaches the node e by using the RTD value RTDₑₙ and a transmission time Tₙ when the node n transmits the signal. The reception time point tₙₑ is represented by Equation below.

$${t}_{ne} = {T}_{n} + \frac{{RTD}_{en}}{2} \qquad [ Equation 2 ]$$

A range of the FFT start time point FFTₑ of the node e for detecting signals received for all the one-hop nodes is represented as in Equation below.

tᵢₑ+CP_{M}≦FFTₑ≦tⱼₑ+CP [Equation 3]

In Equation 3, i is a node index corresponding to

$${arg max}_{n} ( {t}_{ne} ) ,$$

and j is a node index corresponding to

$${arg min}_{n} ( {t}_{ne} ) .$$

Equation below must be satisfied in order for the region where both reception in the existing network and reception in a changed network are possible to exist.

tᵢₑ+CP_{M}≦FFT_{R}, FFT_{L}≦tⱼₑ+CP [Equation 4]

If the conditions of Equation 4 are satisfied, the FFT start time point FFTₑ of the node e may be set within a range, such as that shown in Equation below.

FFT_{L}^{new}≦FFTₑ≦FFT_{R}^{new} [Equation 5]

In Equation 5, FFT_{L}^{new} is max(−G_{R},tᵢₑ+CPₘ), and FFT_{R}^{new} is min(G_{L}+CP,tⱼₑ+CP).

In accordance with Equation 4 and Equation 5, if the FFT start time point FFTₑ is within a specific range, the FFT start time point FFTₑ is set by Equation below.

$${FFT}_{e} = \{ \begin{matrix}{FFT}_{L}^{new} & if {FFT}_{cre} < {FFT}_{L}^{new} \\ {FFT}_{R}^{new} & else if {FFT}_{cre} > {FFT}_{R}^{new} \\ {FFT}_{cre} & otherwise\end{matrix} \qquad [ Equation 6 ]$$

That is, the FFT start time point FFTₑ is set to a value closest to FFT_{cre} within the range between FFT_{L}^{new} and FFT_{R}^{new}. Here, FFT_{cre} is the reference value of the actual FFT change value FFTₑ, and the FFT start time point FFTₑ is set to a value which is closest to the reference value FFT_{cre} to the maximum extent within a possible FFT range when the possible FFT range is given. If FFT_{cre} is smaller than FFT_{L}^{new}, FFTₑ is set to FFT_{L}^{new}, and FFT_{cre} is also changed into FFT_{L}^{new}. If FFT_{cre} is greater than FFT_{R}^{new}, FFTₑ is set to FFT_{R}^{new}, and FFT_{cre} is also changed into FFT_{R}^{new}.

Furthermore, if the value FFT_{cre}^{new} exceeds the range, the value FFT_{cre}^{new} is set again as in Equation below.

$${FFT}_{cre}^{new} = \{ \begin{matrix}- {G}_{R} & if {FFT}_{cre} < - {G}_{R} \\ {G}_{L} + CP & if {FFT}_{cre} > {G}_{L} + CP\end{matrix} \qquad [ Equation 7 ]$$

Meanwhile, if an FFT start time point FFTₑ satisfying the conditions of Equation 4 does not exist in all the reception nodes, distributed synchronization may be performed by selecting a node that is synchronized.

For example, the FFT start time point FFTₑ may be set in a period from the fastest reception time point to a CP after CP_{M} on the basis of a node having the fastest reception time point. For example, the FFT start time point FFTₑ may be calculated by using the remaining nodes other than a node k corresponding to

$${arg max}_{n} ( {t}_{ne} ) .$$

If the FFT start time point FFTₑ does not exist in this case, the FFT start time point FFTₑ is calculated by using the remaining nodes other than the node corresponding to

$${arg max}_{n} ( {t}_{ne} )$$

in the remaining one-hop nodes other than the node k. The node corresponding to

$${arg max}_{n} ( {t}_{ne} )$$

is repeatedly removed until the FFT start time point FFTₑ exists as described above.

For another example, if signals are received from a plurality of nodes, the FFT start time point FFTₑ may be set in the period of a CP length from an average reception time point at which the signals are received from the plurality of nodes on the basis of the average reception time point. For example, if an FFT start time point FFTₑ satisfying the conditions of Equation 5 does not exist, the FFT start time point FFTₑ may be calculated by using the remaining one-hop nodes other than a node k corresponding to a node having a great difference in an average value avg(tₙₑ) between min(tₙₑ) and max(tₙₑ). A node having a great difference in the average value avg(tₙₑ) between min(tₙₑ) and max(tₙₑ) is repeatedly removed until the FFT start time point FFTₑ exists.

If there is no node connected nearby, the FFT start time point FFTₑ maintains a value FFT_{cr} as its initial value.

Next, a relevant one-hop node is requested to change the reference point T_{crk} of a transmission start time point by ΔT_{crk} for the removed node k. The transmission time point is changed in order to minimize interference. ΔT_{crk} has a positive or negative value. If a removed node is a node corresponding to a minimum value, a node corresponding to a maximum value is also requested to change the reference point of a transmission time point. If a removed node is a node corresponding to a maximum value, a node corresponding to a minimum value is also requested to change the reference point of a transmission time point.

The method of determining the transmission time point of a node and changing an FFT start time point according to the present invention the node is described below (embodiment 2).

Like all the nodes, a node e sets a range of a transmission time point for transmission in the existing network as in Equation below.

T_{L}≦Tₑ≦T_{R} [Equation 8]

If the node e is an entry node, T_{L} is “−G_{R}” and T_{R} is G_{L} as the initial values of the above range value.

The node e calculates a reception time point tₑₙ at which a signal transmitted from the node e reaches a neighboring node n at a transmission time point Tₑ by using an RTD value RTDₑₙ with the node n which is estimated in accordance with a ranging method. The reception time point tₑₙ is represented by Equation below.

$${t}_{en} = {T}_{e} + \frac{R T {D}_{en}}{2} \qquad [ Equation 9 ]$$

A range of the transmission time point Tₑ of the node e in which all the one-hop nodes can detect the signal of the node e is represented by Equation below.

$$F F {T}_{i} - C P - \frac{R T {D}_{ei}}{2} \leq {T}_{e} \leq F F {T}_{j} - C {P}_{M} - \frac{R T {D}_{ej}}{2} \qquad [ Equation 10 ]$$

In Equation 10, i is a node index corresponding to

$${arg max}_{n} ( F F {T}_{n} - C P - \frac{R T {D}_{en}}{2} ) ,$$

and j is a node index corresponding to

$${arg min}_{n} ( F F {T}_{n} - C {P}_{M} - \frac{R T {D}_{en}}{2} ) .$$

Equation below must be satisfied in order for the region where both transmission in the existing network and transmission in a changed network are possible to exist.

$$F F {T}_{i} - C P - \frac{R T {D}_{ei}}{2} \leq {T}_{R} , \\ {T}_{L} \leq F F {T}_{j} - C {P}_{M} - \frac{R T {D}_{ej}}{2} \qquad [ Equation 11 ]$$

If the conditions of Equation 11 are satisfied, the transmission time point Tₑ of the node e may be set within a range, such as that shown in Equation below.

T_{L}^{new}≦Tₑ≦T_{R}^{new} [Equation 12]

In Equation 12, T_{L}^{new} is max(−G_{R},FFTᵢ−CP−RTDₑᵢ/2), and T_{R}^{new} is min(G_{L},FFTⱼ−CP_{M}−RTDₑⱼ/2).

In accordance with Equations 11 and 12, if the transmission time point Tₑ exists within a specific range, the transmission time point Tₑ is set as in Equation below.

$${T}_{e} = \{ \begin{matrix}{T}_{L}^{new} & if {T}_{cre} < {T}_{L}^{new} \\ {T}_{R}^{new} & else if {T}_{cre} > {T}_{R}^{new} \\ {T}_{cre} & otherwise\end{matrix} \qquad [ Equation 13 ]$$

That is, the transmission time point Tₑ is set to a value closest to T_{cre} within a range between T_{L}^{new} and T_{R}^{new}. If T_{cre} is smaller than T_{R}^{new}, the transmission time point Tₑ is set to T_{L}^{new}, and T_{cre} is also changed into T_{L}. If T_{cre} is greater than T_{R}^{new}, the transmission time point Tₑ is set to T_{R}^{new}, and T_{cre} is also changed into T_{R}^{new}.

Furthermore, if a value T_{cre}^{new} exceeds the range, the value T_{cre}^{new} is set again as in Equation below.

$${T}_{cre}^{new} = \{ \begin{matrix}- {G}_{R} & if {T}_{cre} < - {G}_{R} \\ {G}_{L} & if {T}_{cre} > {G}_{L}\end{matrix} \qquad [ Equation 14 ]$$

Meanwhile, if a transmission time point Tₑ satisfying the conditions of Equation 11 does not exist for all the reception nodes, a node that is synchronized is selected.

First, the transmission time point Tₑ of the node e may be set in a period having a CP_{F} length on the basis of a node having the fastest reception time point.

For example, a node corresponding to

$${arg max}_{n} ( F F {T}_{n} - C {P}_{M} - R T {D}_{en} / 2 )$$

may be repeatedly removed until the transmission time point Tₑ exists, and the transmission time point Tₑ may be set from the remaining one-hop nodes other than the removed node k.

Furthermore, if signals are received from a plurality of nodes, the transmission time point Tₑ of the node e may be set in a period having a CP_{F} length on the basis of an average reception time point at which the signals are received from the plurality of nodes. For example, if a transmission time point Tₑ satisfying the conditions of Equation 11 does not exist, the transmission time point Tₑ is calculated for the remaining nodes except a node k corresponding to a node having an average value having a great difference between

$${arg min}_{n} ( F F {T}_{n} - C P - \frac{R T {D}_{en}}{2} )$$

and

$${arg max}_{n} ( F F {T}_{n} - C {P}_{M} - \frac{R T {D}_{en}}{2} ) ,$$

and a node having an average value having a great difference between

$${arg min}_{n} ( F F {T}_{n} - C P - \frac{R T {D}_{en}}{2} )$$

and

$${arg max}_{n} ( F F {T}_{n} - C {P}_{M} - \frac{R T {D}_{en}}{2} )$$

is repeatedly removed until the transmission time point Tₑ exists.

If there is no node connected nearby, the transmission time point Tₑ maintains the value T_{cr} as its initial value.

Next, a relevant one-hop node is requested to change an FFT start reference point FFT_{crk} by ΔFFT_{crk} for the removed node k. ΔFFT_{crk} has a positive or negative value. If the removed node is a node corresponding to a minimum value, a node corresponding to a maximum value is also requested to change the reference point of the FFT start time point. If the removed node is a node corresponding to a maximum value, a node corresponding to a minimum value is also requested to change the reference point of the FFT start time point

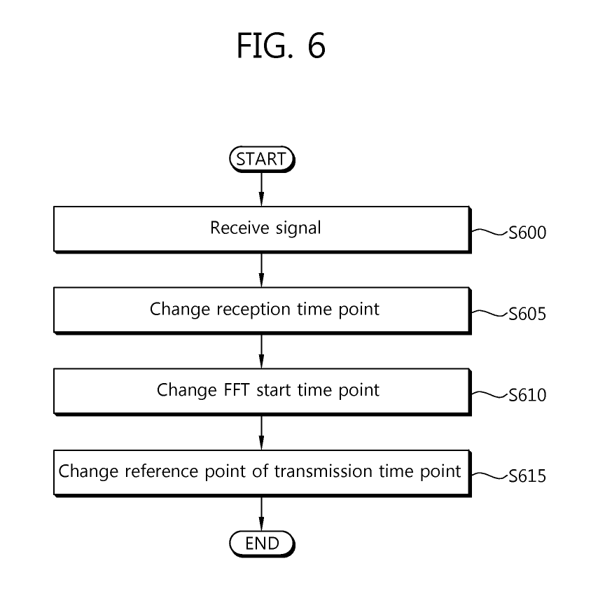

FIG. 6 is a flowchart illustrating an example of a method of performing distributed synchronization in an Ad hoc network system according to the present invention.

A reception terminal receives a signal, including a reception time point change period, through a plurality of nodes at step S600. The reception time point change period may exist between frames or subframes which form the signal. The reception time point change period may be changed with consideration taken of propagation delay occurring when the signal is transmitted.

A reception time point at which the signal is received through the plurality of nodes is changed within the reception time point change period so that the reception time point is included in a preset CP period at step S605. The reception time point may be changed by using Round-Trip Delay (RTD), estimated using a ranging process in which the plurality of nodes is synchronized with reference timing in order to perform multiple-access to one center node without interference or collision, and the transmission time point of each of the plurality of nodes. The CP period may be determined by excluding the region where Inter-Symbol Interference (ISI) is generated.

An FFT start time point (i.e., a time point at which data starts being recovered) is changed based on the changed reception time point at step S610. The FFT start time point may be changed so that it approaches the preset reference point of the FFT start time point to the maximum extent.

For example, the FFT start time point may be changed within the CP period changed on the basis of the fastest reception time point, from among reception time points at which the signal is received through the plurality of nodes. Particularly, if there is a node not included in the CP period, the FFT start time point may be changed within the CP period recalculated and changed by excluding a node having the slowest reception time point, and the reference point of the transmission time point of each of the plurality of nodes may be changed on the basis of the excluded node.

For another example, the FFT start time point may be changed within the CP period changed on the basis of an average time point of reception time points at which the signal is received through the plurality of nodes. In particular, if there is a node not included in the CP period, the FFT start time point may be changed within the CP period changed on the basis of an average time point of the reception time points which is recalculated by excluding a node having the greatest difference in the reception time point from the average time point of the reception time points, and the reference point of the transmission time point of each of the plurality of nodes may be changed on the basis of the excluded node.

The reference point of the transmission time point of each of the plurality of nodes is changed on the basis of a difference value between the preset reference point of the FFT start time point and the changed FFT start time point at step S615.

Each of the plurality of nodes may be a one-hop node.

The present invention may further include the step of calculating reception time points at which a first node receives respective signals transmitted from the plurality of nodes. The FFT start time point may be changed into a time point at which all the CP periods started from the calculated reception time points cross each other.

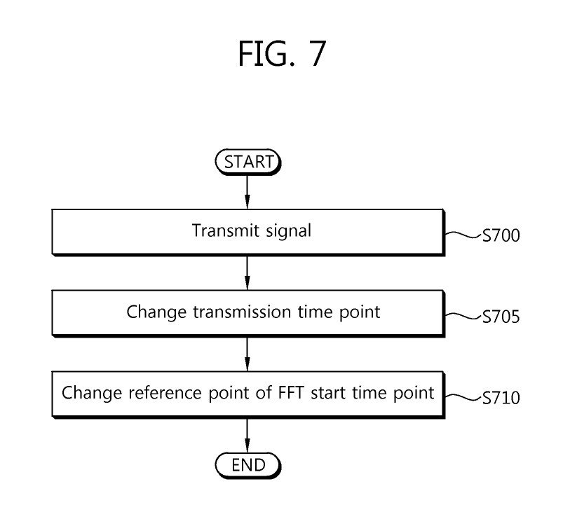

FIG. 7 is a flowchart illustrating another example of a method of performing distributed synchronization in an Ad hoc network system according to the present invention.

A transmission terminal transmits a signal, including a transmission time point change period, through a plurality of nodes at step S700. The transmission time point change period may exist between frames or subframes which form the signal. The transmission time point change period may be changed with consideration taken of propagation delay occurring when the signal is transmitted.

A transmission time point at which the signal is received through the plurality of nodes is changed within the transmission time point change period so that the transmission time point is included in a preset CP period at step S705. The transmission time point may be changed by using Round-Trip Delay (RTD), estimated using a ranging process in which the plurality of nodes is synchronized with reference timing in order to perform multiple-access to one center node without interference or collision, and the reception time point of each of the plurality of nodes. Furthermore, the CP period may be determined by excluding the region where Inter-Symbol Interference (ISI) is generated.

For example, the transmission time point may be changed within the CP period changed on the basis of the fastest reception time point, from among reception time points at which the signal is received through the plurality of nodes.

For another example, the transmission time point may be changed within the CP period changed on the basis of an average time point of reception time points at which the signal is received through the plurality of nodes.

The reference point of an FFT start time point (i.e., a time point at which data starts being recovered) is changed on the basis of a difference value between the changed transmission time points at step S710.

The Ad hoc network system the present invention includes the transmission terminal, including the plurality of nodes described with reference to FIGS. 6 and 7, and the reception terminal, including the plurality of nodes described with reference to FIGS. 6 and 7.

The transmission terminal transmits a signal including a transmission time point change period, changes a transmission time point at which the signal including the transmission time point change period is transmitted within the transmission time point change period so that the transmission time point is included within a preset first CP period, and changes the reference point of a first FFT start time point on the basis of the changed transmission time point.

The reception terminal receives a signal including a reception time point change period, changes a reception time point at which the signal including the reception time point change period is received within the reception time point change period so that the reception time point is included in a preset second CP period, changes a second FFT start time point on the basis of the changed reception time point, and changes the reference point of a transmission time point of the signal on the basis of a difference value between the preset reference point of the second FFT start time point and the changed second FFT start time point.

The distributed synchronization method according to the present invention is advantageous in that it has smaller overhead than a synchronization method of inserting a CP longer than propagation delay according to the distance between nodes is used.

While some exemplary embodiments of the present invention have been described with reference to the accompanying drawings, those skilled in the art may change and modify the present invention in various ways without departing from the essential characteristic of the present invention. Accordingly, the disclosed embodiments should not be construed to limit the technical spirit of the present invention, but should be construed to illustrate the technical spirit of the present invention. The scope of the technical spirit of the present invention is not limited by the embodiments, and the scope of the present invention should be interpreted based on the following appended claims. Accordingly, the present invention should be construed to cover all modifications or variations induced from the meaning and scope of the appended claims and their equivalents.

What is claimed is:

1. A method of performing distributed synchronization in an Ad hoc network system, the method comprising:
receiving a signal, including a reception time point change period, through a plurality of nodes;
changing a reception time point at which the signal is received through the plurality of nodes within the reception time point change period so that the reception time point is included in a preset Cyclic Prefix (CP) period;
changing a Fast Fourier Transform (FFT) start time point which is a time point at which data starts being recovered based on the changed reception time point; and
changing a reference point of a transmission time point of each of the plurality of nodes based on a difference value between a preset reference point of the FFT start time point and the changed FFT start time point.

2. The method as claimed in claim 1, wherein the reception time point change period exists between frames or subframes forming the signal.

3. The method as claimed in claim 1, wherein the reception time point change period is changed based on propagation delay occurring when the signal is transmitted.

4. The method as claimed in claim 1, wherein the reception time point is changed by using Round-Trip Delay (RTD), estimated according to a ranging process in which the plurality of nodes is synchronized with reference timing in order to perform multi-access to one center node without interference or collision, and the transmission time point of each of the plurality of nodes.

5. The method as claimed in claim 1, wherein the CP period is determined by excluding a region where Inter-Symbol Interference (ISI) is generated.

6. The method as claimed in claim 1, wherein the FFT start time point is changed so that the FFT start time point approaches the preset reference point of the FFT start time point to a maximum extent.

7. The method as claimed in claim 1, wherein the FFT start time point is changed within the CP period changed based on a fastest reception time point, from among reception time points at which the signal is received through the plurality of nodes.

8. The method as claimed in claim 7, wherein if there is a node not included in the CP period,
the FFT start time point is changed within the CP period recalculated and changed by excluding a node having a slowest reception time point, and
the reference point of the transmission time point of each of the plurality of nodes is changed based on the excluded node.

9. The method as claimed in claim 1, wherein the FFT start time point is changed within the CP period changed based on an average time point of the reception time points at which the signal is received through the plurality of nodes.

10. The method as claimed in claim 9, wherein if there is a node not included in the CP period,
the FFT start time point is changed within the CP period changed based on an average time point of the reception time points which is recalculated by excluding a node having a greatest difference in the reception time point from the average time point of the reception time points, and
the reference point of the transmission time point of each of the plurality of nodes is changed based on the excluded node.

11. The method as claimed in claim 1, wherein each of the plurality of nodes is a one-hop node.

12. The method as claimed in claim 1, further comprising calculating reception time points at which a first node receives respective signals transmitted from the plurality of nodes, wherein the FFT start time point is changed into a time point at which all CP periods started from the respective calculated reception time points cross each other.

13. A method of performing distributed synchronization in an Ad hoc network system, the method comprising:
transmitting a signal, including a transmission time point change period, through a plurality of nodes;
changing a transmission time point at which the signal is transmitted through the plurality of nodes within the transmission time point change period so that the transmission time point is included in a preset Cyclic Prefix (CP) period; and
changing a reference point of a Fast Fourier Transform (FFT) start time point which is a time point at which data starts being recovered based on the changed transmission time point.

14. The method as claimed in claim 13, wherein the transmission time point change period exists between frames or subframes forming the signal.

15. The method as claimed in claim 13, wherein the transmission time point change period is changed with consideration taken of propagation delay occurring when the signal is transmitted.

16. The method as claimed in claim 13, wherein the transmission time point is changed by using Round-Trip Delay (RTD), estimated according to a ranging process in which the plurality of nodes is synchronized with reference timing in order to perform multi-access to one center node without interference or collision, and a reception time point of each of the plurality of nodes.

17. The method as claimed in claim 13, wherein the CP period is determined by excluding a region where Inter-Symbol Interference (ISI) is generated.

18. The method as claimed in claim 13, wherein the transmission time point is changed within the CP period changed based on a fastest reception time point, from among reception time points at which the signal is received through the plurality of nodes.

19. The method as claimed in claim 13, wherein the transmission time point is changed within the CP period changed based on an average time point of reception time points at which the signal is received through the plurality of nodes.

20. An Ad hoc network system, comprising:
a transmission terminal including a plurality of nodes; and
a reception terminal including a plurality of nodes,
wherein the transmission terminal transmits a signal including a transmission time point change period, changes a transmission time point at which the signal including the transmission time point change period is transmitted within the transmission time point change period so that the transmission time point is included within a preset first CP period, and changes a first FFT start time point based in the changed transmission time point, and
the reception terminal receives a signal including a reception time point change period, changes a reception time point at which the signal including the reception time point change period is received within the reception time point change period so that the reception time point is included in a preset second CP period, changes a second FFT start time point based on the changed reception time point, and changes a reference point of a transmission time point of the signal based on a difference value between a preset reference point of the second FFT start time point and the changed second FFT start time point.
